(19) United States
(12) Patent Application Publication
(10) Pub. No.: US 2004/0058038 A1
(43) Pub. Date: Mar. 25, 2004

(54) Lunch box capable of blastfrozen preservation

(76) Inventor: Young-Kyu Lee, Eumsung-gun (KR)

Correspondence Address: Robert E. Bushnell, Suite 300, 1522 K Street, N.W., Washington, DC, 20005, US

(21) Appl. No.: 10/645,658

(22) Filed: Aug. 22, 2003

(30) Foreign Application Priority Data
Aug. 23, 2002 (KR) 2002-25112
Aug. 7, 2003 (KR) 2003-25444

(51) Int. Cl. A23B 4/00

(52) U.S. Cl. 426/107

(57) ABSTRACT

A lunch box capable of blast frozen preservation. The lunch box has two compartments, having two containers that are concentric with each other. The lunch box can withstand blast freezing and is microwave compatible keeping two separate food components separate from each other. The lunch box is space saving and easily portable. One side dish container fits within the other main dish container.

### CLAIM OF PRIORITY

This application makes reference to, incorporates the same herein, and claims all benefits accruing under 35 U.S.C. §119 from an application for LUNCH BOX CAPABLE OF BLASTFROZEN PRESERVING earlier filed in the Korean Intellectual Property Office on Aug. 23 2002 and Aug. 7, 2003 and assigned Serial Nos. 2002-25112 and 2003-25444 respectively, the contents of which are hereby incorporated by reference.

### BACKGROUND OF THE INVENTION

1. Field of the Invention

The present invention relates to a rigid lunch box capable of holding food in various separate compartments, the lunch box being able to withstand blast freezing and reheating while keeping the food within the various compartments from mixing during the blast freezing and the reheating.

2. Description of the Related Art

Due to the fast paced nature of our society, pre-prepared foods are becoming more and more common. Office workers and students alike often bring pre-prepared foods with them to eat at lunch. One of the major concerns of pre-prepared foods is the presence of harmful and unwanted bacteria in the foods. When foods are mass produced, the food is then chilled or frozen. The chilled or frozen food is bought by the consumer. At lunch time, the consumer heats the food and then eats the heated food.

In order to reduce the bacteria count in foods, pre-prepared foods that are cooked are then blast frozen. Blast freezing reduces the time that the food is at a temperature that bacteria can multiply. Cooked foods are placed in a compartment where the air temperature is below freezing. The below freezing air is circulated within the compartment until the prepared food freezes. The circulation of the air within the compartment and maintaining the circulated air at a very low temperature results in the prepared food freezing quicker, and thus the food is at a temperature where bacteria can multiply for a much shorter period of time than other food preparation methods.

Recently, such prepared foods that undergo blast freezing are first placed in packages before the blast freezing. Each package is generally one portion of the food. In addition, the consumer can then use the same package to reheat the foods using a microwave oven.

However, a single entree is often made up of many foods. It is preferred that each component of the entrees are kept separate during the blast freezing and the reheating to achieve a better flavor and texture when eating. U.S. Pat. No. 5,741,534 to Chung describes a packaging for an entree where the different components of the entree are kept separate during the blast freezing and the reheating. After reheating, the user perforates a thin, flexible partition layer with a knife causing each separate food component to mix. By keeping each of the components of food (e.g., the rice and the gravy) separate until when consumed, the flavor and the texture of the food is maintained at a higher quality than if the food components were mixed prior to blast freezing or prior to reheating.

However, the Chung patent is disadvantageous in that the packaging for the food is designed so that the food must be eaten from the packaging. Because of the flexible partition layer, it becomes almost impossible for the consumer to move each component of food to some other dish, like a bowl or another plate to so the consumer can eat off this other dish. Because the consumer is required to eat from the package in Chung, the packaging is big and bulky and is therefore not suitable for transport to school or work. Worse yet, the plastic partition layer is mixed up in the food, making it difficult for the consumer to 1) separate the food from the plastic partition layer, 2) to remove the plastic partition layer from the mixed food, 3) to mix the food given that the plastic partition layer is embedded within the food and 4) messy for the consumer to remove the partition layer coated with gravy and sauces.

U.S. Pat. No. 4,233,325 to Slagan et al., illustrate in FIG. 8 a first container 20 with a second container 24 disposed within. Ice cream 22 is disposed between a bottom surface of first container 20 and a bottom surface 28 of second container 24. Syrup 32 is disposed in second container 24. Bottom surface 28 of second container 24 keeps syrup 32 separate from ice cream 22. When heated in microwave oven 38 by device 42 from top to bottom, syrup 32 heats up and melts while ice cream 22 does not melt. This is because bottom surface 28 of second container 24 and the sidewalls of first container 20 do not allow microwave radiation to penetrate leaving ice cream 22 cold and frozen while syrup 32 melts. After microwave heating, the syrup 32 is poured over ice cream 22 as illustrated in FIGS. 9 and 10 of Slagan '325

However, the Slagan '325 patent does not allow the bottom food to be heated. Much of the packaging of Slagan '325 is resistant to microwave energy and thus does not allow ice cream 22 to heat up. Although this may be fine for ice cream, if another food was located where the ice cream 22 is in Slagan '325, it would be desirable to also heat the food in the bottom compartment. Thus, it would be desirable to have all of the food packaging or lunch box to be made of a material that does not resist microwave energy.

Therefore, what is needed is a packaging or a lunch box for food, where different components of the entree are kept separate from each other during the blast freezing process and the reheating process so that the consumer can place each food component in a separate dish to eat from after reheating. What is also needed is a food packaging where the partitions are rigid to enable the user to transfer the food to another dish. What is still needed is a packaging that can withstand blast freezing and reheating. What is also needed is a food packaging that has a shape that is easily portable by students and office workers so that the packaging or lunch box is compact. Further, what is needed is a food package that is easy for the consumer to remove the food from and later mix together that is not messy or difficult to handle or difficult to remove from the food or that prevents the consumer from mixing the two components easily. What is also needed is to heat the food in both compartments simultaneously.

### SUMMARY OF THE INVENTION

It is therefore an object of the present invention to provide an improved lunch box that can withstand blast freezing and reheating.

It is also an object of the present invention to provide a lunch box that keeps separate food components physically separated from each other during blast freezing and reheating.

It is further an object of the present invention to provide a lunch box that is rigid enough to allow the user to pour each of the food components into a separate dish after reheating so that the user does not have to eat from the food packaging.

It is further an object of the present invention to provide a lunch box that is compact in shape thus enabling for easy travel to work or school.

It is still an object of the present invention to provide a food lunch box where it is easy for the consumer to easily mix the food components together.

It is yet an object of the present invention to provide a lunch box where the user can mix the food components together after heating without incurring a mess.

It is still an object of the present invention to provide a lunch box where the packaging does obstruct the ability of the user to mix together and eat the two food components after heating and mixing.

It is also an object of the present invention that the food in both compartments are heated simultaneously by using materials for the lunch box that do not resist microwave.

These and other object can be achieved by a food package or lunch box made out of a relatively inflexible material that can withstand blast freezing and is microwave compatible where the material does not resist microwave energy and allows microwave radiation to pass through. The dimensions and shape of the lunch box is that the height, width and length of the lunch box are all close to being equal with each other thus making the lunch box easily portable. The lunch box has a main rice compartment and a second side dish compartment, the side dish compartment fits inside the main rice compartment to conserve space. Since the side dish compartment and the main rice compartment are made of a relatively thick and somewhat rigid material, the contents of both the main rice compartment and the side dish compartment can be emptied into another dish after re heating so that the user is not required to eat from the lunch box.

### BRIEF DESCRIPTIONS OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 illustrates a perspective view illustrating a first embodiment of the present invention;

FIG. 2 illustrates an exploded perspective view illustrating a first embodiment of the present invention;

FIG. 3 illustrates a vertical sectional view illustrating a first embodiment of the present invention;

FIG. 4 illustrates a perspective view illustrating a second embodiment of the present invention;

FIG. 5 illustrates an exploded perspective view illustrating a second embodiment of the present invention;

FIG. 6 illustrates a vertical sectional view illustrating the packing state according to a second embodiment of the present invention; and

FIG. 7 illustrates a perspective view illustrating the packing state according to a second embodiment of the present invention.

### DETAILED DESCRIPTION OF THE INVENTION

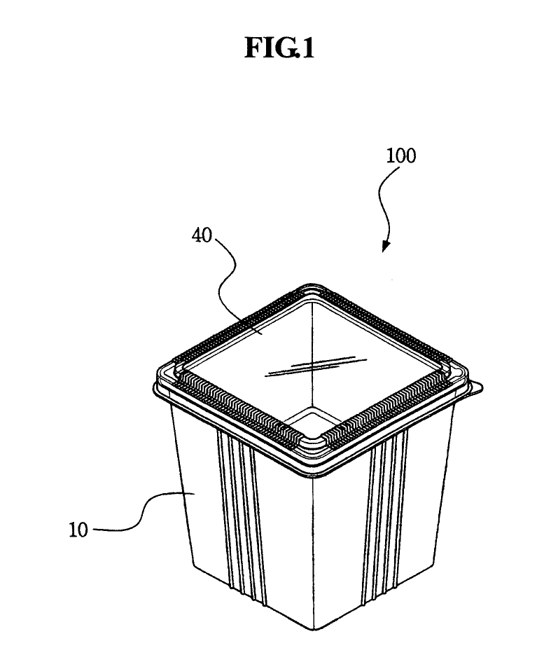

Turning to the figures, FIG. 1 illustrates an exterior of lunch box (or container or packaging) 100 according to the first embodiment of the present invention. Lunch box 100 has main outer container 10 which is covered by an extra cover 40. Although main outer container 10 is illustrated as having a square cross section, it will be appreciated that main outer container 10 may also be of a circular or rectangular cross section. It is noted that the height of lunch box 100 is only slightly larger than either the width, the length, or the diameter of the lunch box, however, this invention is not limited to the exact dimensions of the lunch box 100 illustrated in FIG. 1. In the present invention, none of the height, the width, and the length or diameter is either much larger or much smaller than the other dimensions, resulting in a compact, efficient and easily portable design.

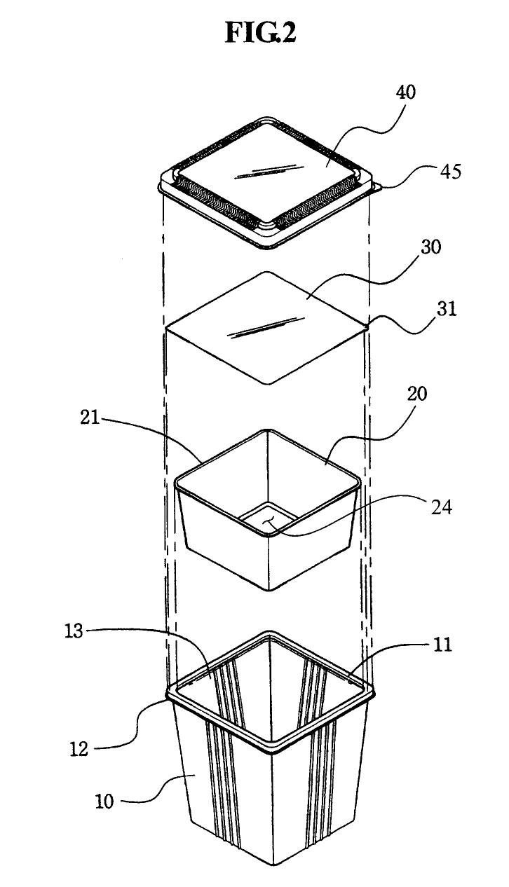

FIG. 2 illustrates an exploded view of the lunch box 100 of FIG. 1 with all of the internal components not illustrated in FIG. 1. In FIG. 2, a side dish container 20 is illustrated. Side dish container 20 fits inside main outer container 10. On the upper edge of the side dish container 20 is a rim 21 that hangs on a sloped indented portion 13 of the main outer container 10. The side dish container 20 is designed so that the contents 102 of the side dish container 20 do not mix with the contents 101 of the main outer container 10. The main outer container has a lip 11 on an upper edge. A sealed paper plate 30 is attached to lip 11 of main outer container 10. Also, a top cover 40 attaches to lip 11 of main outer container 10. Lip 11 has an edge protruding portion 12 at a distal end of lip 11 that locks with locking portion 41 on an inside part of rim 42 of extra cover 40. Main outer container 10 and side dish container 20 are made of a material that is microwave compatible and that can tolerate blast freezing. Microwave compatible means that the lunch box can be put in a microwave oven and the microwave oven can heat the food within the lunch box without melting or destroying the containers of the lunch box.

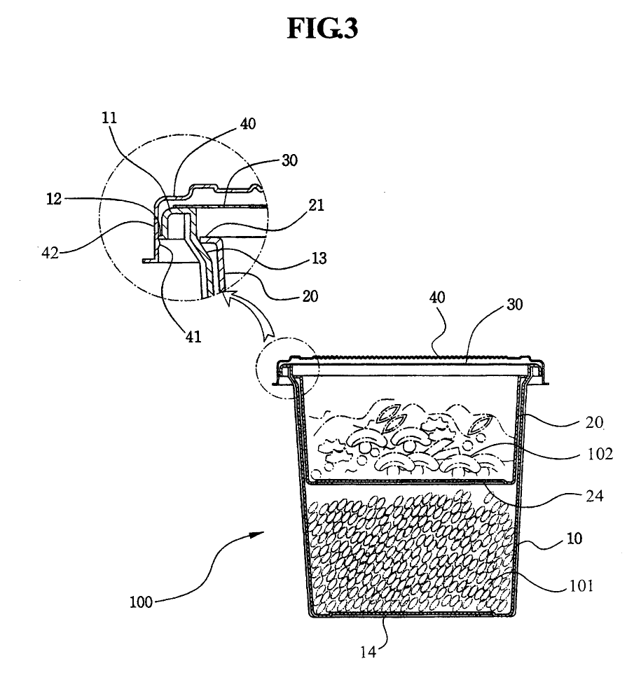

FIG. 3 illustrates lunch box 100 in use and also illustrates in detail the interrelationships of lip 11, edge protruding portion 12, extra cover 40 with locking portion 41, rim 21 and sloped indented portion 13. As illustrated, a first food 101 is disposed within main outer container 10 and below a bottom 24 of side dish container 20 and above a bottom 14 of main dish container 10. A second food 102 is disposed in side dish container 20 on and above bottom surface 24 and the second food 102 does not mix with the first food 101.

As illustrated in FIG. 3, the length and width of side dish container 20 is slightly less than the length and width of main dish container 10 so that side dish container 20 fits within main dish container 10. The rim 22 of side dish container 20 is supported by indented portion 13 of main dish container 10, the indented portion 13 being near the top of main dish container 10 just below the lip 11. In FIG. 3, the height of side dish container 20 is slightly less than half the height of main dish container 10, however, in no way is the present invention limited by the exact height of side dish container 20 or by the exact proportion of the height of side dish container 20 compared to the height of main dish container 10. First food 101 is disposed inside main dish container 10 beneath bottom surface 24 of side dish container 20 and on and above bottom surface 14 of main dish container 10. Preferably, the first food 101 does not contact the bottom surface 24 of side dish container 20. Second food 102 is disposed in side dish container 20 that is formed concentrically within main dish container. Second food 102 is disposed on and above bottom surface 24 of side dish container 20. Bottom surface 24 of side dish container physically separates the first food 101 from the second food 102. Bottom surface 24 of side dish container is made out of a material that is rigid and is not easily pierced with a knife. If a knife were to pierce bottom surface 24, the second food 102 would not fall onto first food 101, even if the second food 102 is runny like gravy or a sauce because of the rigidity of the material that makes up the bottom surface 24 of side dish container 20.

The first food 101 may be cooked rice and the second food 102 may be gravy, vegetables, meat, a sauce or any combination of these items. The second food 102 could also be a soup or a stew. Alternatively, second food 102 may be cooked rice and first food 101 may be gravy, vegetables, meat, a sauce or any combination of these items. It is, preferable to not mix the first food 101 with the second food 102 either prior to blast freezing or prior to reheating as the taste and texture of the food would otherwise be compromised. Further, it is noted that the design of lunch box 100 is so that the user is not required mix the first food 101 with the second food 102 within lunch box 100. Also, it is not required that the user eat the food from lunch box 100. Instead, it is preferable that the user, after heating first food 101 and second food 102 simultaneously, to place first food 101 and second food 102 in a separate dish (not illustrated) for eating. Therefore, first food 101 and second food 102 may be mixed in a separate dish separate from lunch box 100 after heating.

It is also to be appreciated that the bottom surface 24 of side dish container 20 is not made of a material that is easily pierced by a knife. If this bottom surface 24 is pierced by a knife, little or none of second food 102 would fall onto first food 101 as the bottom surface 24 of the side dish container 20 is made of a rigid material.

A process for using the lunch box 100 of the first embodiment of the present invention is as follows. The user brings lunch box 100 to work where the first food 101 and the second food 102 are frozen. The user then heats the lunch box 100 containing the first food 101 and the second food 102 preferably in a microwave oven. To do this, the user removes the extra cover 40 from the lunch box. Then the user grabs the handle part 31 of paper plate 30 and pulls open just a corner of the paper plate 30 to allow steam to escape. Then, the user places the lunch box 100 in a microwave oven and heats the food. When done, the user removes the side dish container 20 from the main dish container 10. Then, the user places the first food 101 and the second food 102 in a plate (not illustrated) and the food is ready to eat. The user may, at this time choose to mix first food 101 with second food 102. For example, if first food 101 is rice and second food 102 is chicken in a curry sauce, the user may first empty the first food 101 onto a plate and then empty second food 102 on top of first food 101 on the plate. This way, the first food 101 and the second food 102 are never in contact until immediately before eating, thus preserving food taste, quality and texture.

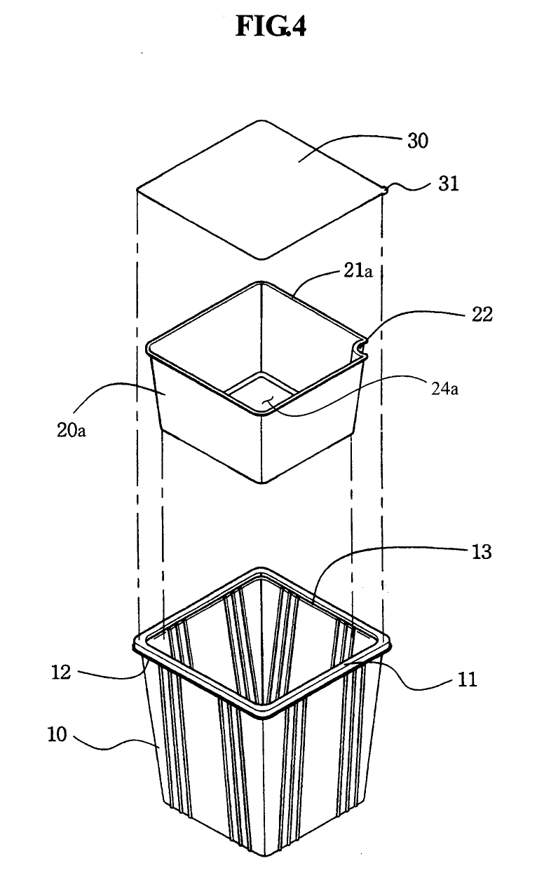

FIGS. 4 through 7 illustrate a lunch box 110 according to the second embodiment of the present invention. The second embodiment is different from the first embodiment in that 1) extra cover 40 is replaced with paper cover 50 and plastic bag 60 and 2) the side dish container 20a contains a groove 22 used to allow steam from first food 101 to escape and to allow the user to easily grip side dish container 20a and easily remove side dish container 20a from main dish container 10.

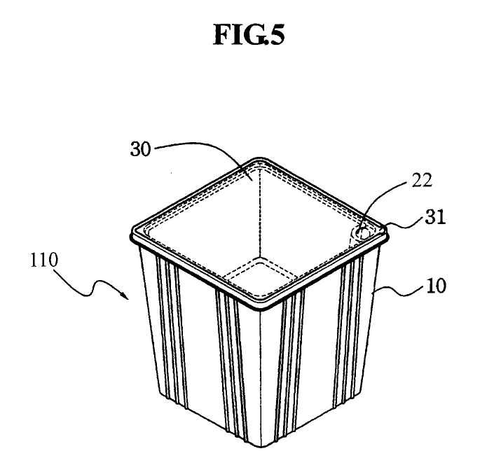

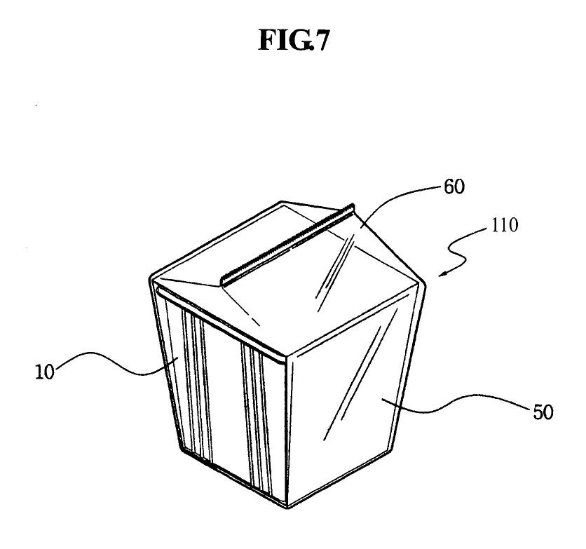

Turning to FIG. 4, FIG. 4 illustrates an exploded view of the lunch box 110 of FIGS. 5 and 7 with all of the internal components not illustrated in FIGS. 5 and 7 according to the second embodiment of the present invention. In FIG. 4, a side dish container 20a is illustrated. Side dish container 20a is identical to side dish container 20 of the first embodiment except side dish container 20a has a steam ejection groove 22 formed in one corner extending from a bottom side 24a of the side dish container 20a to rim 21a. This groove 22 serves two purposes. First, groove 22 allows steam from first food 101 to escape while being heated in the microwave oven. Secondly, groove 22 allows a user to easily separate and remove side dish container 20a from main dish container 10 after heating by insertion of a finger into groove 22.

Turning to FIG. 5, the handle part 31 of sealed paper plate 31 is disposed immediately above groove 22 of side dish container 20a. Just before reheating, the user pulls handle 31 of paper plate 30 revealing groove 22 to allow steam to escape during heating. The user does not entirely remove the paper plate 30 prior to heating so that second food 102 will not dry out during heating.

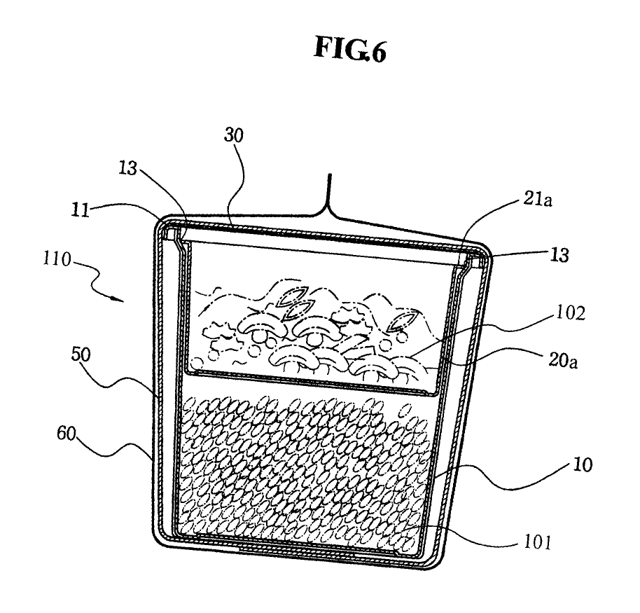

Turning to FIG. 6, FIG. 6 illustrates lunch box 110 filled with first food 101 and second food 102 according to the second embodiment of the present invention. FIG. 6 is similar to FIG. 3 except that paper cover 50 and plastic bag 60 are used instead of extra cover 40. Paper cover 50, for a square or rectangular cross sectional lunch box, has four side panels and a top and a bottom panel, with folds or creases between each adjacent side. Also side dish container has reference numeral 20a instead of 20 because of the presence of groove 22. Paper cover 50 surrounds the entire lunch box 110. Plastic bag 60 surrounds the paper covered lunch box 110. Before heating in a microwave, the user completely removes plastic bag 60 and then tears a small hole in paper cover 50. The user also peals back a corner 31 of sealed paper plate 30 exposing groove 22 of side dish container 20a. The openings in paper cover 50 and paper plate 30 allow steam to escape during heating while keeping the food moist. The escaping steam prevents the lunch box 110 from building up a lot of pressure during heating eventually leading to an explosion.

The above invention enables an entree of at least two food components to be stored in a compact container that can be used in blast freezing and microwave heating. Side dish container fits within and is essentially concentrically disposed within main dish container keeping both food components separate during blast freezing and reheating. After reheating, the user then empties the contents of both the main container and the side dish container into a separate plate or bowl for eating. Thus, the user may mix the first and second foods together in a separate dish after heating. The side dish container fits within the main dish container providing a compact lunch box that is easily portable.

While this invention has been particularly illustrated and described with reference to preferred embodiments thereof, it will be understood by those skilled in the art that various changes in form and details maybe made therein without departing from the spirit and scope of the invention as defined by the appended claims. The preferred embodiments should be considered in descriptive sense only and not for purposes of limitation. Therefore, the scope of the invention is defined by the appended claims.

What is claimed is:

1. A lunch box capable of blast frozen preservation, comprising:
a first container having a lip at a top and an indented portion just below the lip; and
a second container having a rim at a top, the second container being disposed within the first container, the rim of the second container being supported by the indented portion of the first container, wherein a space is formed between a bottom surface of the second container and a bottom surface of the first container, the bottom surface of the second container physically separating a second food disposed in the second container from a first food disposed in the first container beneath the bottom surface of the second container.

2. The lunch box of claim 1, the first container and the second container being microwave compatible, allowing microwave radiation to pass through and able to withstand blast freezing.

3. The lunch box of claim 1, the bottom surface of the second container is rigid and inflexible.

4. The lunch box of claim 1, further comprising a cover that attaches to said lip of said first container that seals an interior of said first and said second container.

5. The lunch box of claim 1, said second container having a groove running an entire height of said second container from said bottom surface to the rim of said second container enabling steam to escape from said first food when heated.

6. The lunch box of claim 1, further comprising a paper plate sealed to said lip of said first container preventing said second food, said first food and said second container from being separated from an interior of said first container.

7. The lunch box of claim 1, said first container being surrounded by a sealed paper cover.

8. The lunch box of claim 1, said first food does not contact said bottom surface of said second container.

9. The lunch box of claim 7, said first container being surrounded by a sealed plastic bag.

10. A lunch box capable of blast frozen preservation, comprising:
an outer container having essentially a shape of a cup, having a bottom surface and a lip at a top; and
an inner container disposed within the outer container, the inner container having a shape similar to the shape of the outer container, the inner container having a height of about one half a height of the outer container, the inner container being supported solely by the outer container, the outer and the inner container being made entirely out of a material that can withstand blast freezing, that is microwave compatible and is made entirely of a material that is microwave-permeable.

11. The lunch box of claim 10, the inner container having a bottom surface, the bottom surface of the inner container being parallel to and separated from the bottom surface of the outer container by a distance of about one half the height of the outer container.

12. The lunch box of claim 10, further comprising a seal disposed on said lip of said outer container sealing the inner container and any food inside the inner container and any food inside the outer container within said outer container.

13. The lunch box of claim 10, the inner container having a rim that is supported by the lip of the outer container.

14. The lunch box of claim 10, the inner container being concentric with said outer container.

15. The lunch box of claim 10, the inner container and the outer container both being rigid and inflexible.

16. The lunch box of claim 10, the inner and the outer container being non-porous.

17. A blast freezable, microwave compatible and microwave permeable apparatus, comprising:
a first container having a bottom surface, side walls and a lip opposite from said bottom surface, said side walls being disposed between said bottom surface and said lip;
a second container disposed within said first container, said second container being supported by said first container, said second container having a bottom surface and a rim opposite said bottom surface, said bottom surface of said second container being separated from said bottom surface of said first container by a distance roughly equal to a distance between said rim and said bottom surface of said second container;
a first food disposed within said first container between said bottom surface of said first container and said bottom surface of said second container, said first food not being in contact with said bottom surface of said second container; and
a second food disposed within said second container, said second food being separated from said first food by said bottom surface of said second container, said first food never mixing with said second food.

18. The apparatus of claim 17, said first and said second container being made entirely of a material that is microwave compatible, that can withstand blast freezing and that allows microwave radiation to pass through.

19. The apparatus of claim 17, said bottom surface of said second container being non-flexible and non-porous.

20. The apparatus of claim 17, further comprising a cover attached to said lip of said first container and enclosing said first food, said second food and said second container within said first container.
